(19) United States
(12) Patent Application Publication
(10) Pub. No.: US 2010/0114677 A1
(43) Pub. Date: May 6, 2010

(54) SYSTEM INCLUDING AUTOMATED TELLER MACHINE WITH DATA BEARING MEDIUM

(76) Inventors: Mark Carlson, Half Moon Bay, CA (US); Patrick Faith, Pleasanton, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/266,352

(22) Filed: Nov. 6, 2008

(51) Int. Cl. G06Q 30/00; G06Q 40/00; G01C 21/00; G06Q 10/00

(52) U.S. Cl. 705/14.1; 705/10; 701/213

(57) ABSTRACT

Embodiments of the present invention relate to systems and methods of providing customized offers to a consumer at an automated teller machine. The automated teller machine comprises a processor, a computer readable medium coupled to the processor, an output device coupled to the processor, and a reader coupled to the processor. The computer readable medium comprises code for receiving data from a portable ATM device and code for receiving a customized offer after receiving data from the portable ATM device.

### BACKGROUND

Banks provide automated teller machines (ATMS) so that consumers can conduct banking transactions without having to go into the bank. ATMs are often located to be easily accessible to consumers.

Sometimes, banks provide ATM locators on their websites to allow consumers to search for ATMs in a given area. Typically, consumers search for ATMs by city, by address (e.g., zip code), or by using an interactive map. The ATM locators provide addresses and maps showing the location of ATMs. The consumer can go to one of the ATMs identified to get cash or conduct other ATM transactions.

Some prior ATMs dispense generic coupons on the back of transaction receipts to consumers. Prior ATMs do not have access to information to customize coupons for their consumers.

### SUMMARY

Embodiments of the invention relate to methods and systems of providing customized offers at ATMs. Such customized offers can be based on the location of a consumer and also past transaction history data associated with the consumer.

One embodiment of the invention is directed to an automated teller machine comprising a processor, a computer readable medium coupled to the processor, an output device coupled to the processor, and a reader coupled to the processor. The computer readable medium comprises code for receiving data from a portable ATM device and code for receiving a customized offer after receiving data from the portable ATM device.

Another embodiment of the invention is directed to a method of interacting with an automated teller machine and receiving a customized offer from the automated teller machine. In some cases, the customized offer is based on purchasing preferences of a consumer and data related to a location of the consumer.

Another embodiment of the invention is directed to a method that determines a location of a consumer, wherein the consumer is located proximate to an automated teller machine. The method further determines a customized offer using purchasing preferences of the consumer and data related to the location of the consumer. The method also sends a message to the automated teller machine that causes the automated teller machine to provide the customized offer to the consumer.

In addition, an embodiment of the invention is directed to a system comprising an automated teller machine and a payment processing network communicating with the automated teller machine. The payment processing network comprises server. The server has a computer readable medium comprising code for determining a location of a consumer, wherein the consumer is located proximate to the automated teller machine. The computer readable medium also comprises code for determining a customized offer using purchasing preferences of the consumer and data related to the location of the consumer. The computer readable medium also comprises code for sending a message to the automated teller machine. The message causes the automated teller machine to provide the customized offer to the consumer.

These and other embodiments of the invention are described in further detail below.

### BRIEF DESCRIPTION OF THE DRAWINGS

FIG. 1 is a block diagram illustrating a system that provides customized offers at ATMs, in accordance with an embodiment of the invention.

FIG. 2 is a block diagram of an exemplary ATM, in accordance with an embodiment of the invention.

FIG. 3 is a block diagram of an exemplary mobile phone, in accordance with an embodiment of the invention.

FIG. 4 is a flow chart illustrating a method of providing customized offers to a consumer at an ATM, in accordance with an embodiment of the invention.

FIG. 5 shows a webpage that provides an example of an ATM locator that could be provided by an ATM locator module, in accordance with an embodiment of the invention.

FIG. 6 is a diagram of an exemplary coupon, in accordance with an embodiment of the invention.

FIG. 7 shows a block diagram of subsystems that may be present in computer apparatuses that are used in the system, according to embodiments of the invention.

### DETAILED DESCRIPTION

Embodiments of the invention are directed to methods and systems of providing customized offers at ATMs. The customized offers may be determined using the location of the consumer as well as the data relating to prior transactions conducted by the consumer.

The location of the consumer can be determined in any suitable manner. For example, in one embodiment, a consumer may use an ATM locator on a website (e.g., an issuer's website) to search for one or more available ATMs in a particular location. Alternatively, the current location of the consumer can be determined automatically using a global positioning system (GPS) element on the consumer's mobile phone, in the consumer's car etc. Other location based methods, including the determination of mobile phone signal strength can be used to determine the consumer's location. Yet another location based determination method involves the use of the a consumer's credit and debit cards. For instance, when a consumer purchases an item from a particular merchant, a server computer in a payment processing network can determine the location of that merchant, and hence the location of the consumer.

Once the consumer's location is determined, a server computer may generate a customized offer for the consumer. The customized offer may be based on the consumer's purchasing preferences (which may be determined using past transaction data) and the current location of the consumer. The customized offer is then sent to one or more ATMs that the consumer is expected to be close to. If the consumer chooses to use one or more of the ATMs, the ATM provides the customized offer to the consumer. For example, an ATM may dispense the customized offer on a paper receipt or may send it to the consumer's mobile phone.

The consumer can redeem the customized offer immediately. The customized offer can be for a merchant that is close to the ATM that dispensed the customized offer.

Certain embodiments of the invention may provide one or more technical advantages to issuers, consumers, and merchants. Prior ATMs do not dispense customized offers. A technical advantage to merchants may be that providing customized offers to consumers at ATMs near their places of business may give them a new avenue for local marketing. Offers customized to target consumers with certain consumption preferences located near the merchant's place of business can be more effective in generating revenue. In addition, merchants may be able to minimize their marketing expenditures by only marketing locally or to consumers with certain purchasing preferences. A technical advantage to issuers may be that issuers can dispense customized offers to their consumers over their ATMs and thus attract marketing revenue from local merchants. A technical advantage to consumers may be that consumers receive customized offers instead of generic offers that they cannot use or are inconvenient to use. Since the customized offers will be based on the location and purchasing preferences of the consumer, the consumer can minimize the travel costs needed to take advantage of offers. Also, the offers made will be more likely to be for products and services that are useful or desirable to the consumer. A further technical advantage can be that customized offers can be provided to ATMs that the consumer is likely to visit. Once it is determined that the consumer is no longer at a particular location, data relating to customized offers can be removed, thus reducing the data storage requirements of the system.

Certain embodiments of the invention may include none, some, or all of the above technical advantages. One or more other technical advantages may be readily apparent to one skilled in the art from the figures, descriptions, and claims included herein.

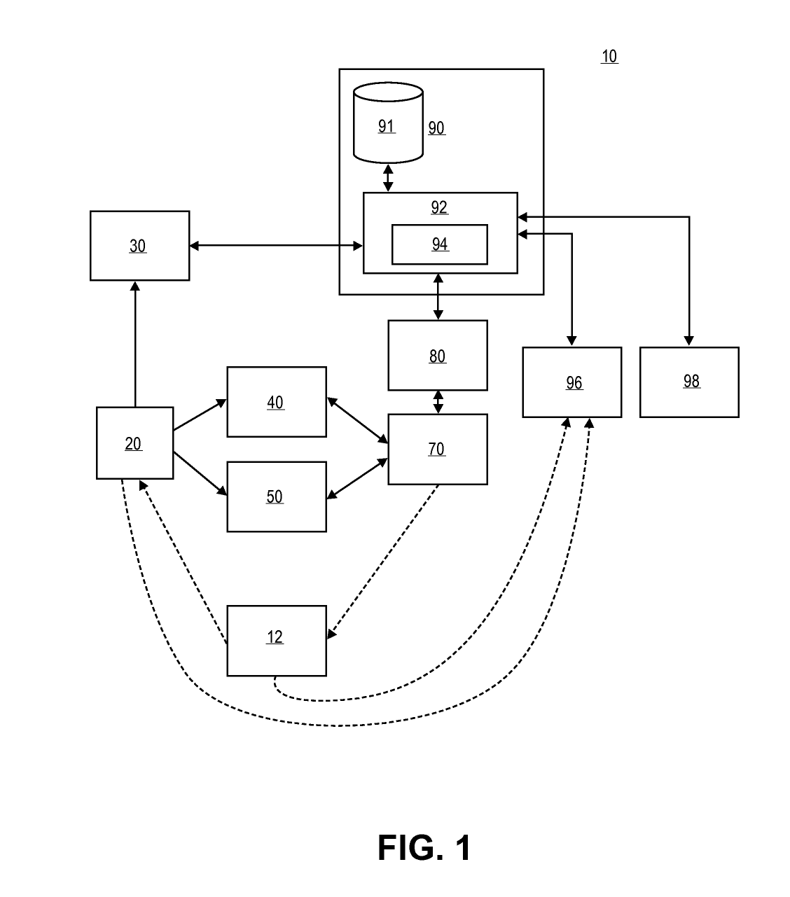

FIG. 1 is a block diagram illustrating a system 10 that provides customized offers at ATMs, in accordance with an embodiment of the invention. System 10 includes a coupon 12 with one or more customized offers. System 10 also includes a consumer 20 in operative communication with a client computer 30, a mobile phone 40, and an ATM card 50. System 10 also includes an ATM 70 that dispenses coupon 12 to consumer 20. Mobile phone 40 is in wireless communication with ATM 70. ATM card 50 is in communication with ATM 70 so that consumer 20 can conduct transactions at ATM 70. System 10 also includes an issuer 80 in communication with a payment processing network 90 and in operative communication with ATM 70. The payment processing network 90 comprises a server computer 92 having an ATM locator module 94 for providing an ATM locator on a web browser on client computer 30. A consumer preference database 91 may be in communication with the server computer 92 and may store consumer preference data. System 10 also includes a merchant A 96 and a merchant B 98 for providing server computer 92 with information about their offers to consumers 20 locating near ATM 70. Server computer 92 is in communication with client computer 30 to provide an ATM locator on a web browser displayed on client computer 30. Server computer 92 is also in communication with issuer 80 to provide a customized offer to issuer 80. Issuer 80 sends a message to ATM 70 to dispense coupon 12 with the customized offer at a local merchant A 96 to consumer 20 at ATM 70. Consumer 20 takes coupon 12 to local merchant A 96 to redeem coupon 12.

Although the illustrated embodiment shows one consumer 20, one client computer 30, one mobile phone 40, one ATM card 50, one coupon 12, one ATM 70, one Issuer 80 and two merchants, it is understood that other embodiments can have any number of these entities.

An offer refers to an incentive given to consumer 20 to purchase products/services. In many cases, offers require purchasing products/services. Offers are provided by merchants. Some examples of offers include discounts, rebates such as manufacturers' rebates, trade-in options, bonus offering, give-aways i.e. free items, and rewards such as reward points given for purchases. Discounts can be of any suitable type such as, for example, single product discounts, bulk discounts, cross-promotional discounts, or cash discounts. Cross promotional discounts typically involve combined offers from one or more merchants.

Customized offers are offers that are customized for a consumer 20 based on purchasing preferences of consumer 20 and data related to the location of consumer 20 i.e. location data. Purchasing preference data can be stored in database 91. Purchasing preferences can be determined based on historical transaction data of the consumer 20, based on preferences selected by the consumer 20, or based on other suitable criteria. For example, a purchasing preference may be determined from historical transaction data that consumer 20 buys coffee at 9:00 a.m. every weekday morning.

Purchasing preference data used to determine the offers for the consumer 20 can be determined in any suitable manner. In one example, the consumer 20 can specifically indicate his or her preferences on a website (not shown) operated by the server computer 92. For example, the website may have various drop down menus and other selection mechanisms to allow a consumer to select preferences for food (e.g., fast food vs. fine dining, specific restaurants), preferences for goods (e.g., clothes, jewelry, etc.), preferences for services (e.g., drycleaners, etc.), etc. In another example, the consumer's preferences may be determined without the consumer specifically selecting his or her preferences. For example, the consumer's transaction history data can be used to determine preferences. For example, the consumer 20 can conduct many credit and/or debit card transactions which can pass through the payment processing network 90. The payment processing network 90 may be in communication with various acquirers, and issuers associated with the debit and/or credit cards that are used by the consumer 20. The account numbers for those debit and/or credit cards can be linked to the account number associated with the ATM card 50, so that the server computer 92 in the payment processing network 90 can link transaction data associated with the consumer's debit and credit cards with the consumer's ATM card 50.

Location data refers to information that is associated with the current location of consumer 20 and/or the destination location of consumer 20. For example, location data could include information such as a data from a GPS element or signal strength data that can be used to determine the current geographical location of mobile phone 40 and thus consumer 20. As another example, location data could include a destination address of consumer 20. In one case, consumer 20 uses ATM locator to search for an ATM 70 closest to a destination address by entering the destination address. The location of the closest ATM(s) 70 to that destination address would be determined based on the desired destination address. Location data can also include the time and date that the location data is acquired.

In some embodiments if the consumer 20 is expected to be at a particular location at a particular time, then more than one ATM may be identified as being ready to dispense a customized offer to the consumer 20. For example, if the consumer is at, or is expected to be at, 1 Market Street, in San Francisco, Calif., then ATMs within 1 mile of this location may be ready to dispense a customized offer to the consumer 20 in anticipation of the consumer's use of one or more of those ATMs.

In some embodiments, one or more components of the system 10 may include a timeout feature, whereby customized offers would no longer be provided by ATMs, because the consumer 20 is not expected to be in the vicinity of the ATMs. For example, in the above example, if the server computer 92 determines that the consumer 20 was at 1 Market Street, San Francisco, Calif. at noon, and the server computer 92 can subsequently determines (using any combination of the location determination methods described herein) that the consumer 20 is not 20 miles away from 1 Market Street, then the server computer 92 need not retain information about customized offers for the consumer 20 near 1 Market Street.

Coupon 12 refers to any suitable notification of one or more offers. In some cases, coupon 12 may be negotiable certificate that can be redeemed with the merchant and/or the manufacturer. In other cases, coupon 12 may be a notice that a merchant is having a sale on one or more products or services. Coupons 12 can be printed coupons or electronic coupons. Printed coupons can be on a paper receipt or other paper dispensed from ATM 70. In another embodiment, a customized offer may be transmitted to the consumer's phone 40 upon interaction with the ATM 70. The customized offer can be transmitted directly from the ATM 70 to the phone 40 using a wireless link (e.g., an RF link or an IR link). In another embodiment, a customized offer can be sent to mobile phone 40 after interaction with the ATM 70 using a short messaging service (SMS) message, a multimedia messaging service (MMS) message, or an email message.

Consumer 20 refers to an individual, or an organization such as a business that is capable of purchasing goods or services. In some cases, Consumer 20 has an account associated with ATM card 50 where the account is operated by issuer 80.

Client computer 30 can be a desktop computer, a laptop computer, a cellular or mobile phone, a personal digital assistant (PDA), or other suitable device. In some embodiments, client computer 30 and mobile phone 40 are embodied in the same device.

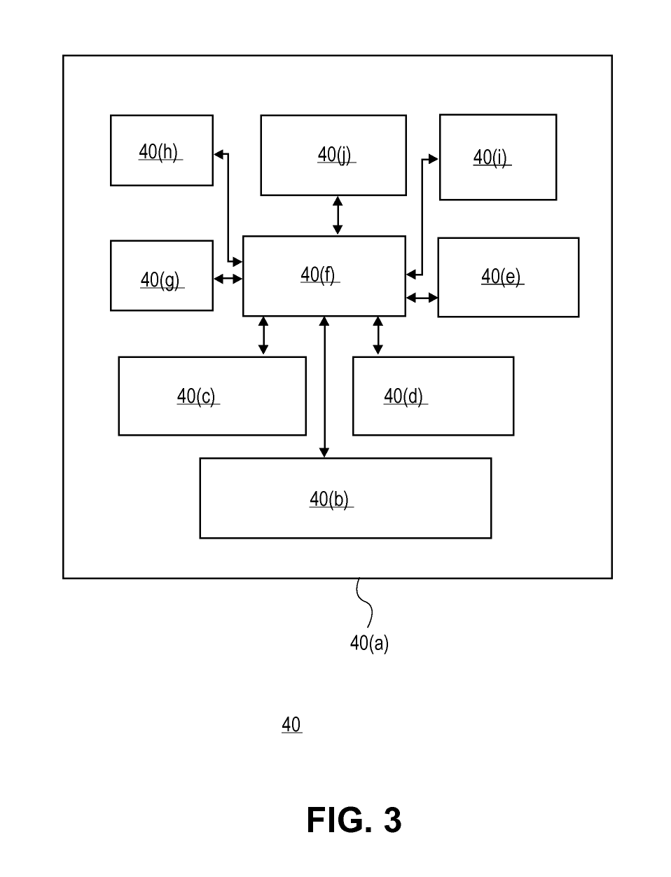

Mobile phone 40 can be in any suitable form. An exemplary embodiment of mobile phone 40 is shown in FIG. 3. In some embodiments, mobile phone 40 also allows consumer 20 to display a web browser with the issuer's website having the ATM locator and/or allows consumer 20 to conduct transactions with merchants. Examples of suitable communication devices include a cellular phone, a personal digital assistant (PDA), a pager, transponders, and the like. In one embodiment, mobile phone 40 and client computer 30 are embodied in the same device. In another embodiment, mobile phone 40, ATM card 50, and client computer 30 are embodied in the same device.

ATM card 50 refers to a card that allows consumer 20 to conduct transactions with ATM 70. In some embodiments, consumer 20 can also use ATM card 50 to conduct transactions with merchants such as merchant A 96 and merchant B 98. In other embodiments, the ATM card 50 could alternatively be in the form of a key fob, phone, etc. A “portable ATM device” may be a device such as a card, fob, or phone, that allows a consumer to interact with an ATM to obtain cash or the like.

ATM card 50 may include any suitable component to perform its functions. In one embodiment, ATM card 50 may include a contactless transmitter for sending wireless signals, a processor (e.g., a microprocessor) for processing the functions of ATM card 50, and a computer readable medium (CRM). These elements are in communication with each other. In other embodiments, ATM card 50 may also include a contactless receiver for receiving wireless signals. In other embodiments, the ATM card 50 may simply have a magnetic stripe which contains data such as the consumer's account number, PIN data, etc.

ATM 70 refers to any suitable device that functions to allow consumer 20 to conduct transactions with issuer 80 using their ATM card 50. Some examples of ATM transactions include withdrawing cash from an account and dispensing to consumer 20, transferring funds from one account to another account, paying bills, changing account information, balance inquiry, transaction inquiry, rewards inquiry, and loan inquiry. ATM 70 includes any suitable component that performs the functions of ATM 70. Some functions of ATM 70 include conducting ATM transactions, dispensing cash to consumer 20, printing and dispensing receipts and other papers to consumer 20, displaying information to consumer 20 such as information about customized offers, and receiving and reading ATM card 50.

The illustrated embodiment shows an ATM 70 associated with issuer 80. In other embodiments, ATM 70 may be associated with another issuer. For example, consumer 20 may use ATM card 50 at an ATM 70 that is in the same ATM network.

System 10 can also include a communication link such as a wireless communication link between ATM 70 and mobile phone 40.

Issuer 80 refers to any suitable entity that may open and maintain an account associated with ATM card 50 for consumer 20. Some examples of issuers may be a bank, a business entity such as a retail store, or a governmental entity. In many cases, issuer 80 may also issue ATM card 50 to consumer 20.

Payment processing network 90 may include data processing subsystems, networks, and operations used to support and deliver: a) data services for managing transaction data, purchasing preferences, and offers provided by merchants, b) services for customizing offers based on purchasing preferences and location information, c) services for managing coupons provided to consumers 20 d) authorization services, e) exception file services, and f) clearing and settlement services. An exemplary payment processing network 90 may include VisaNet™. Networks that include VisaNet™ are able to process credit card transactions, ATM transactions, debit card transactions, prepaid card transactions, and other types of commercial transactions. VisaNet™, in particular, includes a VIP system (Visa Integrated Payments system) which processes authorization requests and a Base II system which performs clearing and settlement services. Payment processing network 90 may use any suitable wired or wireless network, including the Internet.

Payment processing network 90 comprises a server computer 92. Server computer 92 refers to a powerful computer or cluster of computers. For example, server computer 92 can be a large mainframe, a minicomputer cluster, or a group of servers functioning as a unit. Server computer 92 includes any hardware, software, other logic, or combination of the preceding for servicing the requests of one or more remote computers such as client computer 30.

Server computer 92 comprises an ATM locator module 94 for providing an ATM locator (not shown) on a web browser displayed on client computer 30. An ATM locator refers to a webpage or an element on a webpage of issuer's website that allows consumer 20 using client computer 30 to input information to locate an ATM 70. ATM locator module 94 is connected to a communication medium such as a wide area network (e.g., the Internet) that is in communication with client computer 30.

In some embodiments, consumer 20 uses client computer 30 to access a web browser displaying ATM locator on one or more webpages of issuer's website. For example, an ATM locator may allow consumer 20 to enter data related to the current location of consumer 20 or other location that consumer 20 would like to search for ATMs. Consumer 20 may enter, for example, a city and country, a zip code, a street intersection, a street address, a area code, or other suitable data related to a geographical location.

Payment processing network 90 may also include one or more databases 91 coupled to server computer 92. A database refers to any hardware, software, firmware, or combination of the preceding for storing and facilitating retrieval of information. A database may use any of a variety of data structures, arrangements, and compilations to store and facilitate retrieval of information. The database 91 may store transaction data associated with various consumers conducting transactions with debit and/or credit cards. It may also store data relating to consumer preferences so that customized offers can be generated.

Merchants such as merchant A 96 and merchant B 98 refer to any suitable entity or entities that provide offers to consumer 20 and/or conduct transactions with consumer 20. Merchants can be of any suitable type such as retailers of products, manufacturers of products, and service providers. Some examples of merchants include a department store, a gas station, a drug store, a grocery store, a product manufacturer, or other suitable business.

Merchant A 96 and merchant B 98 may have a place of business in any suitable location. In the illustrated embodiment, merchant A 96 and merchant B 98 have a place of business proximate to ATM 70. In another embodiment, merchant A 96 and merchant B 98 have a place of business at some location between the current location of consumer 20 and ATM 70.

Although not shown, merchants may have an access device for interacting with ATM card 50 and/or with mobile phone 40. Some examples of suitable access devices include POS devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. The access device may use any suitable contact or contactless mode of operation to send to or receive data from ATM card 50 and mobile phone 40.

Modifications, additions, or omissions may be made to system 10 without departing from the scope of the disclosure. The components of system 10 may be integrated or separated according to particular needs. Moreover, the operations of system 10 may be performed by more, fewer, or other system modules. Additionally, operations of system 10 may be performed using any suitable logic comprising software, hardware, other logic, or any suitable combination of the preceding.

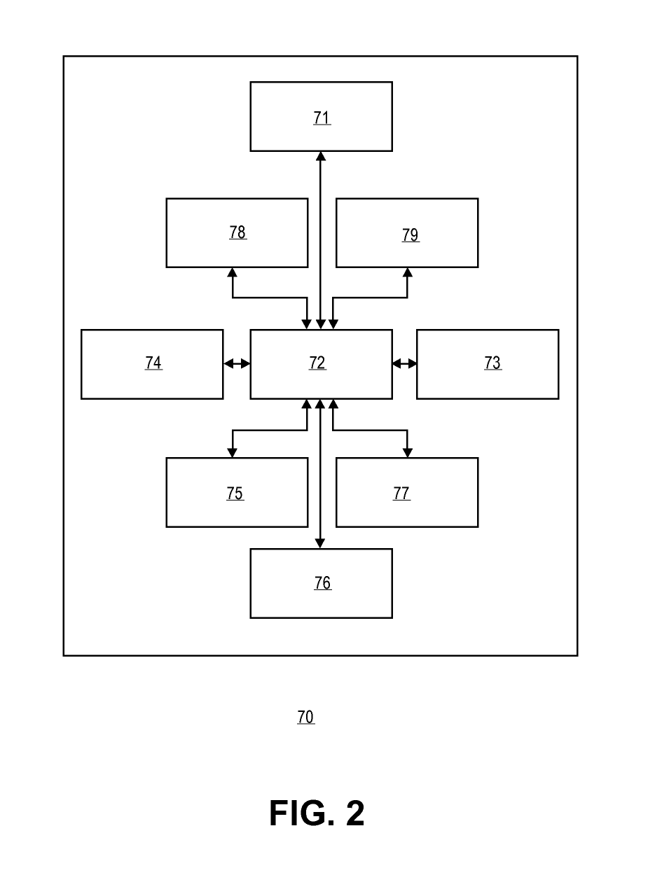

FIG. 2 is a block diagram of an exemplary ATM 70, in accordance with an embodiment of the invention. ATM 70 comprises a processor 72 for processing the operations of ATM 70. ATM 70 also comprises an input device 75 for receiving input from consumer 20. Some examples of suitable input devices 75 include keypads, buttons, touchscreens, microphones, or other suitable input elements. ATM 70 also comprises an output device 76 for providing information to consumer 20. Some examples of suitable output devices 76 include display screens, speakers, printed output, or other suitable output elements. Input device 75 and output device 76 are in communication with processor 72.

ATM 70 also includes a CRM (computer readable medium) 73 for storing code having instructions that allow ATM 70 to operate. Processor 72 is in communication with CRM 73 to execute the code with the instructions. Some suitable code may include instructions to be able to receive a message requesting that a customized offer be sent to the consumer 20 interacting with ATM 70, instructions to send a coupon with a customized offer to the mobile phone 40 of consumer 20 or otherwise provide the customized offer to the consumer 20, instructions to print a coupon with a customized offer, and/or instructions to determine a customized offer based on purchasing preferences and/or data related to the location of consumer 20.

ATM 70 also includes a reader 77 in communication with processor 72. Reader 77 refers to any suitable device capable of interacting with and receiving information from ATM card 50. Exemplary readers 77 include RF (radio frequency) antennas, magnetic stripe readers, etc.

ATM 70 also includes a network interface 74 in communication with processor 72. Network interface 74 may include any suitable device or devices that allow ATM 70 to send message to and receive messages from an external network. In some cases, the ATM 70 may include a contactless element 71 (e.g., a contactless receiver and/or transmitter) for providing a communication link to mobile phone 40 proximate to ATM 70.

ATM 70 also includes a cash reader and dispenser 78 for reading bills and dispensing the bills to consumer 20. ATM 70 also includes a printer and dispenser device 79 for printing and dispensing the print to consumer 20. Prints can be of any suitable types such as receipts, coupons, etc. Cash reader and dispenser 78 and a printer and dispenser device 79 are in communication with processor 72.

Modifications, additions, or omissions may be made to the exemplary ATM 70 in FIG. 2 without departing from the scope of the disclosure. The components of exemplary mobile phone 40 may be integrated or separated according to particular needs. Moreover, the operations of exemplary ATM 70 may be performed by more, fewer, or other modules. Additionally, operations of exemplary ATM 70 may be performed using any suitable logic comprising software, hardware, other logic, or any suitable combination of the preceding.

FIG. 3 is a block diagram of an exemplary mobile phone 40, in accordance with an embodiment of the invention. Mobile phone 40 comprises a body 40(a) in the form of a housing or other structure. Mobile phone 40 also comprises a processor 40(f) (e.g., a microprocessor) for processing the functions of mobile phone 40. Mobile phone 40 also comprises a computer readable medium (CRM) 40(g) and GPS element 40(h) for determining the geographical location of mobile device 40. Mobile phone 40 also comprises a contactless element 40(b) and an antenna 40(j) for sending and receiving wireless signals with data. Mobile phone 40 also comprises a display 40(e) to allow a consumer to see phone numbers and other information and messages, input element 40(c) to allow a consumer (or presenter) to input information into mobile device 40, a speaker 40(d) to allow the consumer to hear voice communication, music, etc., and a microphone 40(i) to allow the consumer to transmit her voice through mobile phone 40. CRM 40(g), GPS element 40(h), contactless element 40(b), antenna 40(j), display 40(e), input elements 52, speaker 40(d), and microphone 40(i) are in communication with processor 40(f).

CRM 40(g) may be a memory that stores data and may be in any suitable form including a magnetic stripe, a memory chip, and the like. CRM 40(g) may store any suitable data such as location data, financial information, transit information (e.g., as in a subway or train pass), access information (e.g., as in access badges), etc.

In this embodiment, location data includes information provided by GPS element 40(h) such as information related to the current geographical location of consumer 20 and mobile phone 40, and the time and date that the GPS element 40(h) acquired the information. Financial information may include information such as bank account information, bank identification number (BIN), credit or debit card number information, account balance information, expiration date, contact information of consumer 20, personal information of consumer 20 such as name, date of birth, etc. Any of this information may be transmitted by mobile phone 40.

Contactless element 40(b) may include a contactless receiver for receiving wireless signals and/or a contactless transmitter for sending wireless signals with data stored in CRM 36 to a contactless receiver on another device. In one example, contactless element 40(b) may include a semiconductor chip (or other data storage element) with an associated wireless transfer (e.g., data transmission) element, such as an antenna. Contactless element 40(b) is associated with (e.g., embedded within) mobile phone 40 and data or control instructions transmitted via a cellular network may be applied to contactless element 40(b) by means of an interface (not shown). The interface functions to permit the exchange of data and/or control instructions between the mobile device circuitry (and hence the cellular network) and contactless element 40(b).

Contactless element 40(b) is capable of sending and receiving data using a near field communications (NFC) capability (or near field communications medium) Typically, NFC capability is in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between Mobile phone 40 other devices such as ATM 70. Thus, mobile phone 40 is capable of receiving and sending data and/or control instructions via both a cellular network and near field communications capability.

Antenna 40(j) may allow consumer 20 to send coupon 12 in electronic form to a point of sale (POS) device at a merchant A 96. Antenna 40(j) may also be used to communicate location information stored on CRM 40(g) derived from GPS element 40(h) to the ATM 70, or to a phone company to forward it to payment processing network 90 (shown in FIG. 1). Antenna 40(j) may communicate information to the ATM 70 or to the POS device in any contactless manner.

In other embodiments, the functionality and/or components of ATM card 50 may be incorporated into mobile phone 40. For example, consumer 20 could interacts their mobile phone 40 with reader 77 of ATM 70 to transmit identification and authentication information from a contactless element 40(b) of mobile phone 40 to a contactless receiver of reader 77 of ATM 70.

Modifications, additions, or omissions may be made to the exemplary mobile phone 40 in FIG. 3 without departing from the scope of the disclosure. The components of exemplary mobile phone 40 may be integrated or separated according to particular needs. Moreover, the operations of exemplary mobile phone 40 may be performed by more, fewer, or other modules. Additionally, operations of exemplary mobile phone 40 may be performed using any suitable logic comprising software, hardware, other logic, or any suitable combination of the preceding.

In a typical process, consumer 20 interacts their ATM card 50 with reader 77 of ATM 70 to provide identification and authentication information to reader 77. Consumer 20 may provide this information to initiate a transaction at ATM 70 such as withdrawing cash. In some cases, ATM card 50 may have a magnetic stripe with the identification and authentication information. Consumer 20 inserts ATM card 50 into ATM 70, and it passes through a card reader of reader 77. In other cases, ATM card 50 may have a contactless transmitter. Consumer 20 holds ATM card 50 near a contactless receiver of reader 77 to send a wireless signal with the information to the reader 77.

The processor 72 receives information from the ATM card 50 via the reader 77. Processor 72 forwards the information through network interface 74 to issuer 80 associated with ATM 70. Issuer 80 forwards the information to server computer 92 in the payment processing network 90.

Before or after the consumer 20 interacts with the ATM 70, the server computer 92 receives offers from merchants such as merchants A and B 96, 98. The server computer 92 can retrieve offers from the merchants after the consumer 20 interacts with the ATM 70, or the merchants may send offers to the server computer 92 in advance; before the consumer 20 interacts with the ATM 70. If the server computer 92 receives offers from merchant A and B 96, 98 in advance of consumer 20 interacting with ATM 70, server computer 92 has additional time to generate customizations of the offers.

Server computer 92 customizes the offers based on the purchasing preferences and location data. Server computer 92 determines an ATM 70 proximate to the geographical location of consumer 20. Server computer 92 determines which of the received offers are from local merchants having a place of business near the ATM 70. Server computer 92 determines which offers from local merchants match the purchasing preferences of consumer 20. The matched offers are the customized offers. For example, consumer 20 may go to an ATM 70 at 9 a.m. to withdraw cash. Server computer 92 analyzes three offers: 1) an offer for free coffee a Starbucks coffee store next to the ATM 70, 2) an offer for a 10% discount on jewelry at a shop next to the cafe, and 3) an offer for a 10% discount at a grocery store across town. Since the consumer 20 is currently located at the ATM 70, serve computer 92 selects the first two offers from local merchants as possible offers to provide to the consumer 20. Server computer 92 can also review the transaction data associated with consumer 20 (stored in the database 91) to determine which of the two offers would most likely be used by the consumer 20. For example, the server computer 92 may determine that that consumer 20 makes frequent purchases at Starbucks, but rarely goes to jewelry stores, after analyzing transaction data that is accumulated from the consumer's credit and debit card purchases. Given those purchasing preferences, server computer 92 determines that the free coffee offer from Starbucks matches the purchasing preferences of consumer 20 and is the customized offer. Prior ATMs have not provided customized offers to consumers based on purchasing preferences of consumer 20.

After determining customized offer(s), server computer 92 sends a message to ATM 70 with the customized offer. After the consumer 20 interacts with the ATM 70, it responds by providing coupon 12 with the customized offer to consumer 20.

Consumer 20 can receive the customized offer in any suitable way. For example, consumer 20 can receive the customized offer on a printed coupon on a transaction receipt or other paper. In another example, a coupon code with the customized offer is outputted on an output device 76 of ATM 70 by displaying the code on a screen or announcing the code over a speaker. In yet another example, consumer 20 receives a coupon code with the customized offer on his mobile phone 40 in the form of a text message, email, voicemail, or other suitable notification. Consumer 20 can use the coupon code or printed coupon to redeem the customized offers at the merchant. Since the consumer 20 is located at the ATM 70, consumer 20 may have cash from the ATM 70, may know their current balance in their account by a balance inquiry at ATM 70, or may have deposited funds into their account using the ATM 70. Thus, consumer 20 is more likely to know they have funds to purchase products at local merchants. Presenting the coupon to the consumer 20 at the ATM 70 provides an opportunity of providing a customized offer at the time that the consumer 20 has funds to take advantage of the customized offer.

In another embodiment, server computer 92 may determine which of the offers received from merchants match the purchasing preferences of consumer 20. Mobile phone 40 may send location data to server computer 92 indicating that consumer 20 has arrived at a particular ATM 70. Server computer 92 may determine which of the offers matching the purchasing preferences is also associated with merchants proximate to the particular ATM 70 that consumer 20 has arrived at. The determined offers are the customized offers. Server computer 92 sends a message to ATM 70 to provide one or more of the customized offers to consumer 20.

In yet another embodiment, server computer 92 determines which of the received offers are from merchants that have a place of business at a location between the location of consumer 20 and ATM 70. Server computer 92 determines which of these offers match the purchasing preferences of consumer 20 and the matching offers are the customized offers provided to consumer 20.

In one embodiment, server computer 92 provides a website, which can be displayed on a web browser on client computer 30. ATM locator module 94 of server computer 92 provides an ATM locator. Consumer 20 uses ATM locator to locate an ATM 70 based on location data (e.g., a zip code). The location data may be associated with the geographical location of consumer 20 or a desired destination. Consumer 20 inputs the location data and receives a list of one or more ATMs 70 that are proximate to the location data. Server computer 92 may use this location data and purchasing preferences determined from transaction data associated with consumer's accounts to determine customized offers for consumer 20. Server computer 92 sends the customized offers to one or more of the ATMs 70 on the list. For example, server computer 92 may send a customized offer to the closest ATM according to the location data. When the consumer 20 interacts with the ATM 70 to conduct a transaction, ATM 70 prints and dispenses a paper (e.g., a coupon) with the customized offer to consumer 20. In this embodiment, server computer 92 has advance notice that the consumer 20 will be travelling to the one or more ATMs 70. Advance notice gives the server computer 92 additional time to generate customized offers. With this additional time, server computer 92 could, for example, request additional offers from local merchants. These new offers may be more up-to-date that the offers already received by server computer 92. With this additional time, server computer 92 could also generate potential offers based on recent transaction data and present them to local merchants for approval to provide to consumer 20. Thus, this additional time allows the server computer 92 to provide up-to-date offers to consumer 20.

In one embodiment, consumer 20 requests that customized offers be provided to him. For example, consumer 20 could be withdrawing cash at an ATM 70 and ATM 70 displays the message “Would you like to receive a coupon from a local merchant?” on its output device 76. Consumer 20 could select a button that indicates “Yes, I would like to receive a coupon.” In response, ATM 70 could provide a coupon with a customized offer. In another example, consumer 20 could request customized offers on issuer's website on a web browser displayed on client computer 30. In response, server computer 92 could send the requested offers to be displayed on client computer 30 so that consumer 30 can print them on an attached printer. Alternatively, server computer 92 could sent the requested offers to the particular ATM 70 that consumer 20 is going to and ATM 70 can provide the customized offers to consumer 20.

In one embodiment, consumer 20 could select one or more customized offers from a list of customized offers. For example, ATM 70 could provide a list of customized offers to consumer 20 on output device 76 of ATM 70. Consumer 20 could select one or more of the customized offers on the list. ATM 70 would provide the selected offers to consumer 20. In some cases, consumer 20 could select an option to display a list of customized offers by category (e.g., fast food) or by merchant.

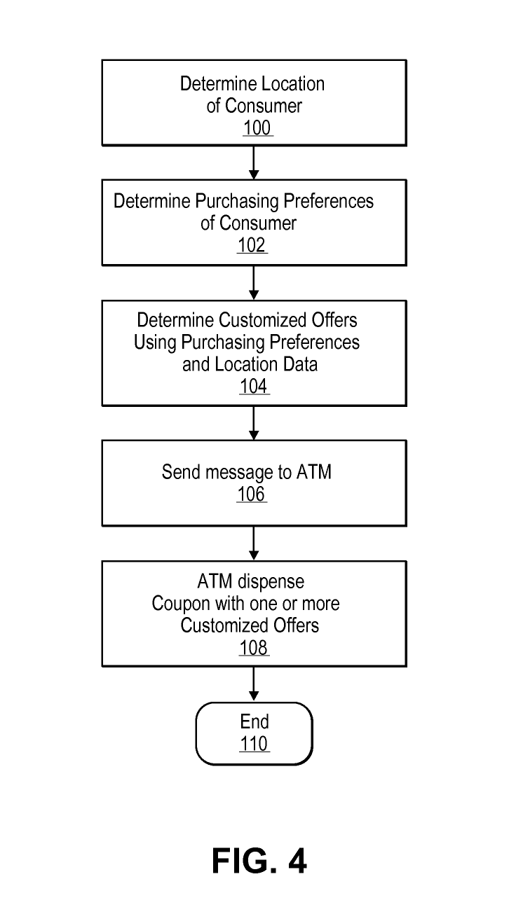

FIG. 4 is a flow chart illustrating a method of providing customized offers to a consumer at an ATM 70, in accordance with an embodiment of the invention.

The geographical location of consumer 20 is determined from location data (step 100). For example, the GPS element 40(h) on mobile phone 40 determines location data. The location data is transmitted in a wireless signal through antenna 40() to a wireless receiver at payment processing network 90. Server computer 92 determines the geographical location of the phone 40 (and hence the consumer 20) based on the location data. As noted above, the location of the consumer could be determined in other ways.

In another embodiment, the location data from GPS element 40(h) of mobile phone 40 is transmitted in a wireless signal to a telecommunication entity (e.g., a telephone company) associated with mobile phone 40. The telecommunication entity determines the geographical location of mobile phone 40 based on location data received from mobile phone 40. The telecommunication entity forwards the location data with the geographical location of mobile phone 40 to server computer 92 of payment processing network 90.

After determining the location of the consumer 20, the purchasing preferences of consumer 20 are determined by server computer 92 (step 102). In some cases, server computer 92 determines the purchasing preferences based on transaction data. Server computer 92 may analyze all transactions or a subset of all transactions such as the last N transactions (e.g., 10, 100 or 1000) conducted using ATM card 50, the consumer's debit cards, and/or the consumer's credit cards. For example, server computer 92 may determine that based on the last 1000 transactions conducted using ATM card 50, the consumer's debit card, and the consumer's credit card, the consumer 20 prefers Mexican fast food over other types of fast food. In other cases, server computer 92 may determine purchasing preferences from information provided by consumer 20. For example, consumer 20 may indicate on a website on the server computer 92 that he does not want to receive fast food offers.

Server computer 92 determines customized offers using purchasing preferences and the location data (step 104). Before or after determining the location of the consumer 20, server computer 92 receives a plurality of offers from merchants. Server computer 92 then selects a subset of the offers received from the local merchants near the geographical location of consumer 20 using the consumer preference information. This determination may result in more than one customized offer.

Server computer 92 then sends a message to ATM 70 (step 106). The message includes the one or more customized offers and a request to ATM 70 to provide consumer 20 with the one or more customized offers.

After the ATM 70 receives the message with the customized offer, the ATM 70 provides the one or more customized offers to consumer 20 (step 108). ATM 70 then dispenses a transaction receipt with the one or more customized offers. In one case, ATM 70 dispenses a printed coupon 12 on a paper such as a transaction receipt. In another case, ATM 70 may transmit a wireless signal with coupon codes associated with the customized offers to mobile phone 40. In another case, ATM 70 may display the coupon codes on output device 76 of ATM 70 or announce the code of a speaker of ATM 70. After ATM 70 provides the one or more customized offers, the method ends (step 110).

Modifications, additions, or omissions may be made to the method without departing from the scope of the disclosure. The method may include more, fewer, or other steps. Additionally, steps may be performed in any suitable order without departing from the scope of the disclosure.

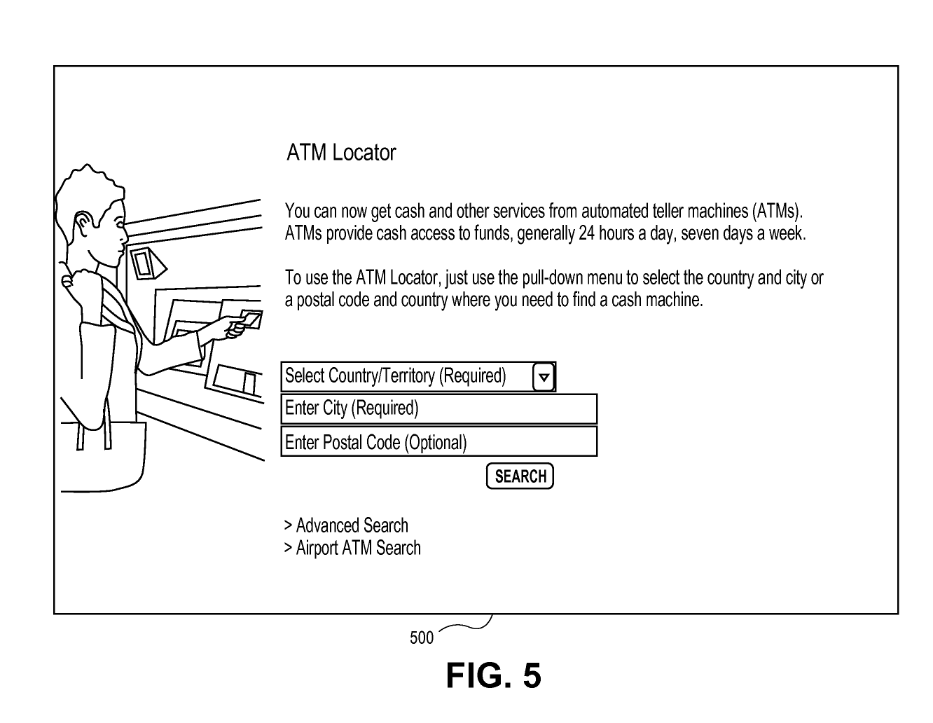

FIG. 5 shows a webpage 500 that provides an example of an ATM locator that could be provided by ATM locator module 94, in accordance with an embodiment of the invention. Consumer 20 can enter location data such as the country and city or a postal code and country. This location data is communicated to the ATM locator module 94 of payment processing network 90. The ATM locator module 94 determines one or more ATMs proximate to the location and displays the locations of the proximate ATMs on ATM locator.

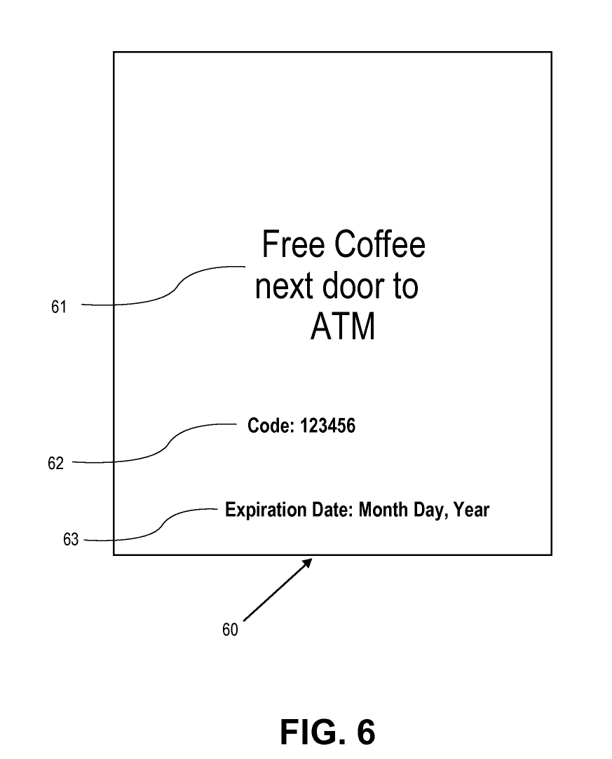

FIG. 6 is a diagram of an exemplary coupon 12, in accordance with an embodiment of the invention. Coupon 12 comprises a customized offer 61 for “Free Coffee next door at Merchant A.” Coupon 12 also comprises a code 62 of “123456.” Codes refer to values that can be used by the merchant to identify and/or authenticate the offer. Codes can also be used by consumer 20 to redeem the coupon 12. In addition to number codes, a bar code or other identifier may be used. Coupon 12 also comprises an expiration date 63 of “Month Day, Year.”

In this example, coupon 12 is printed on the back of a transaction receipt dispensed by ATM 70. In other examples, coupon 12 may be printed on a separate receipt or on the bottom of the transaction receipt.

To redeem coupon 12, consumer 20 provides coupon 12 to merchant A 96. Merchant A 96 can read the code to identify coupon 12 and redeem coupon 12 for consumer 20.

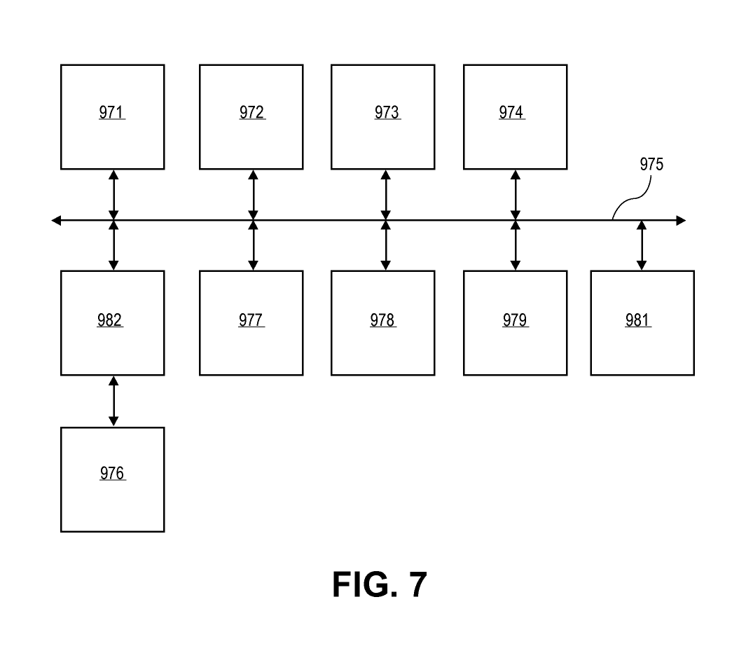

FIG. 7 shows a block diagram of subsystems that may be present in computer apparatuses that are used in system 10, according to embodiments of the invention.

The various components in the previously described Figures may operate using one or more computer apparatuses to facilitate the functions described herein. Any of the elements in the Figures may use any suitable number of subsystems to facilitate the functions described herein. Examples of such subsystems or components are shown in a FIG. 7. The subsystems shown in FIG. 7 are interconnected via a system bus 975. Additional subsystems such as a printer 974, keyboard 978, fixed disk 979 (or other memory comprising computer readable media), monitor 976, which is coupled to display adapter 982, and others are shown. Peripherals and input/output (I/O) devices, which couple to I/O controller 971, can be connected to the computer system by any number of means known in the art, such as serial port 977. For example, serial port 977 or external interface 981 can be used to connect the computer apparatus to a wide area network such as the Internet, a mouse input device, or a scanner. The interconnection via system bus allows the central processor 973 to communicate with each subsystem and to control the execution of instructions from system memory 972 or the fixed disk 979, as well as the exchange of information between subsystems. The system memory 972 and/or the fixed disk 979 may embody a computer readable medium. Any of these elements may be present in the previously described features. For example, the previously described server computer 92 may have directory server and access control server may have one or more of these components shown in FIG. 7.

A computer readable medium according to an embodiment of the invention may comprise code for performing any of the functions described above. For example, the previously described server computer 92 may comprise a computer readable medium comprising: a) code for determining purchasing preferences, b) code for determining the location of consumer 20 based on location data b) code for determining a customized offer using purchasing preferences and location data, c) code for sending messages to ATM 70 including a message that causes ATM 70 to provide a customized offer to consumer 20, d) code for authenticating consumer 20, and/or e) code for approving and settling transactions. Server computer 92 may also have a processor coupled to the computer readable medium, where the processor executes instructions embodied by computer code on the computer readable medium. In another example, the previously described CRM 73 of ATM 70 may comprise: a) code for determining purchasing preferences, b) code for determining customized offers using purchasing preferences and location data, c) code for receiving location data and determining a location of consumer 20 based on location data, d) code for communication with server computer 92, mobile phone 40, and issuer 80, and/or e) code for conducting ATM transactions with consumer 20.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

What is claimed is:

1. An automated teller machine comprising:
a processor;
a computer readable medium coupled to the processor, wherein the computer readable medium comprises code for receiving data from a portable ATM device, and code for receiving a customized offer after receiving data from the portable ATM device;
an output device coupled to the processor; and
a reader coupled to the processor.

2. The automated teller machine of claim 1 wherein the computer readable medium comprises code for generating the customized offer.

3. The automated teller machine of claim 1 wherein the customized offer is printed on paper.

4. A method comprising:
interacting with an automated teller machine; and
receiving a customized offer after interacting with the automated teller machine.

5. The method of claim 4, wherein the customized offer is based on purchasing preferences of a consumer and data related to a location of the consumer, wherein the purchasing preferences are based on transaction data relating to past purchases made by the consumer using at least one of the consumer's ATM card, credit card, and debit card.

6. The method of claim 5, wherein the data related to the location of the consumer is provided by a global positioning system element of a mobile phone.

7. The method of claim 5, wherein the data related to the location of the consumer is provided by a locator module.

8. The method of claim 5, wherein the location of the consumer is the location of the automated teller machine.

9. The method of claim 5, wherein the customized offer is provided by one or more merchants located proximal to the automated teller machine.

10. The method of claim 5, wherein the customized offer is provided by one or more merchants located between the location of the consumer and the automated teller machine.

11. The method of claim 4, wherein the customized offer is received from the automated teller machine.

12. The method of claim 4,wherein the customized offer is printed on a receipt dispensed from the automated teller machine.

13. The method of claim 4,wherein the customized offer is provided to a consumer's mobile phone using a wireless communication link between the automated teller machine and the consumer's mobile phone.

14. A method comprising:
determining a location of a consumer, wherein the consumer is located proximate to an automated teller machine;
determining a customized offer using purchasing preferences of the consumer and data related to the location of the consumer; and
sending a message to the automated teller machine, wherein the message causes the automated teller machine to provide the customized offer to the consumer.

15. The method of claim 14, wherein the customized offer is printed on a receipt dispensed by the automated teller machine.

16. The method of claim 14, wherein the customized offer is provided to a consumer's mobile phone using a wireless communication link between the automated teller machine and the consumer's mobile phone.

17. The method of claim 11, wherein the purchasing preferences are determined from historical data of transactions conducted using an ATM card of the consumer.

18. A computer readable medium comprising code for performing the method of claim 14.

19. A server computer comprising the computer readable medium of claim 18.
